(19) United States
(12) Patent Application Publication
(10) Pub. No.: US 2023/0153609 A1
(43) Pub. Date: May 18, 2023

(54) METHOD AND SYSTEM FOR REFINING COLUMN MAPPINGS USING BYTE LEVEL ATTENTION BASED NEURAL MODEL

(71) Applicant: INNOVACCER INC., SAN FRANCISCO, CA (US)

(72) Inventors: Shubham GUPTA, Bhopal (IN); Vibhuti AGRAWAL, Bangalore (IN); Rishika KHANDELWAL, Jaipur (IN)

(21) Appl. No.: 17/988,505

(22) Filed: Nov. 16, 2022

(30) Foreign Application Priority Data
Nov. 18, 2021 (IN) 202111053056

(51) Int. Cl. G06N 3/08

(52) U.S. Cl. CPC G06N 3/08

(57) ABSTRACT

A method and a system for refining column mappings using byte level attention based neural model are disclosed. Based on a plurality of synthetic data and a plurality of input column names, an encoded data is generated for each of the one or more by present in the input column names. The encoded data is used to train a deep learning (DL) model having a word level auto regressive decoder for identifying at least one meaning for each byte of each of the received plurality of input column names. Further, a plurality of pre-existing column descriptions may be used to determine whether or not the identified at-least one meaning matches with at least one description of the plurality of column descriptions. Subsequently, fine tuning or refining of the meanings may be conducted to adequately obtain corresponding mapping prediction output.

### CROSS REFERENCE TO RELATED APPLICATION

This application claims benefit of Indian Application Serial No. 202111053056 filed Nov. 18, 2021, the entire disclosure of which is incorporated herein by reference.

### TECHNICAL FIELD

The present subject matter relates to data processing and more particularly to refining column mapping between tables by using attention-based neural model.

### BACKGROUND

A database schema typically defines the structure of data organization in multiple rows and columns. The columns are used to define the data type in a table, while the rows include the values and metadata with respect to a column name. An important aspect of data organization is the process of table mapping, wherein a column from a source table is mapped to that of a target table. However, for adequate mapping of the columns, it is important to deduce correct meanings of the column names. A column name may include different words, alphanumeric strings, abbreviations etcetera. A given column name comprising a word, or an alphanumeric string, or an abbreviation may or may not have a similar meaning when compared to another column name. For example, a column name ‘FST_NAM’ from a source table and another column name ‘FIRST_NAME’ from a target table may provide the same meaning. The meanings can also change because of the context that would generate from a given table. Depending on the context, the first name could be related to a physician or nurse or a member. Also, if the meanings behind any assigned column names is not deduced correctly, the mapping process will end with errors.

Generally, ingestion data comes from multiple sources and are in multiple different formats. In such a scenario, it is very likely that the columns' names of different tables comprise different names. It therefore takes a lot of time and effort to perform mapping processes for columns having different names, schemas and formats. Moreover, because of the sensitivity of data it becomes a crucial and prolonged task to deduce the correct meanings of the different column names. Multiple sources such as different data architects and business teams can decide different naming conventions and schemas for their exposed data source. Generally, the column names are analysed manually to understand the meaning of a given column name and to accordingly proceed further. A lookup table may be created using raw data and historical data to probabilistically identify meanings of the existing column names.

In view of the above, a heretofore unaddressed need exists in the industry to address the aforementioned deficiencies and inadequacies.

### SUMMARY

In order to provide a holistic solution to the above-mentioned limitations, it is necessary to deploy an advanced deep learning (DL) model to thereby enhance results by verification of matching predictions from the DL model's provided choices.

An object of the present subject matter is to facilitate in refining column mapping between tables by using attention-based neural model.

Another object of the present subject matter is to provide automated mapping of columns between tables of various formats and for various domains.

Yet another object of the present subject matter is to determine the most relevant meaning behind a given column name with respect to the context of the table's metadata.

Yet another object of the present subject matter is to determine meaningful information about the existing schema's columns.

Yet another object of the present subject matter is to refine mapping of column names from a source's input table to existing schema-based tables using a byte level attention based neural network architecture.

According to an embodiment of the present subject matter, there is provided a method for refining column mappings, the method comprises: configuring a processing unit, the processing unit executing a plurality of computer instructions stored in a memory for: configuring a synthetic data generator for generating synthetic data based on pre-existing mapping data; receiving, in an encoder, the synthetic data and a plurality of input column names, each of the plurality of column names being a group of one or more bytes; generating, by the encoder, an encoded data for each of the one or more bytes; deploying the generated encoded data to train a deep learning (DL) model for identifying at least one meaning for each byte of each of the received plurality of input column names; configuring a mapping output generator based on a plurality of pre-existing column descriptions; using the mapping output generator to determine whether or not the identified at-least one meaning matches with at least one description of the plurality of column descriptions, and thereby obtain an error score; using the error score to fine tune the DL model for thereby providing refined meanings for a given column name and obtain corresponding mapping prediction output.

According to an embodiment of the present subject matter, the encoder is a byte level encoder.

According to an embodiment of the present subject matter, the encoder is a byte pair encoder.

According to another embodiment of the present subject matter, the DL model is an attention based neural model.

According to yet another embodiment of the present subject matter, the pre-existing mapping data includes one or more sample data received from one or more data sources.

According to yet at other embodiment of the present subject matter, the DL model uses a combined context of all columns of a given source table while mapping a current column name.

According to yet another embodiment of the present subject matter, a quality check is performed on the obtained mapping prediction output.

According to an embodiment of the present subject matter, a system for refining column mappings is disclosed. The system comprises a processing unit executing a plurality of computer instructions stored in a memory to: configure a synthetic data generator for generating synthetic data based on pre-existing mapping data; receive, in an encoder, the synthetic data and a plurality of input column names, each of the plurality of column names being a group of one or more bytes; generate, by using the encoder, an encoded data for each of the one or more bytes; deploy the generated encoded data to train a deep learning (DL) model for identifying at least one meaning for each byte of each of the received plurality of input column names; configure a mapping output generator based on a plurality of pre-existing column descriptions; use the mapping output generator to determine whether or not the identified at-least one meaning matches with at least one description of the plurality of column descriptions, and thereby obtain an error score; and use the error score to fine tune the DL model for thereby providing refined meanings for a given column name and obtain corresponding mapping prediction output.

The afore-mentioned objectives and additional aspects of the embodiments herein will be better understood when read in conjunction with the following description and accompanying drawings. It should be understood, however, that the following descriptions, while indicating preferred embodiments and numerous specific details thereof, are given by way of illustration and not of limitation. This section is intended only to introduce certain objects and aspects of the present invention, and is therefore, not intended to define key features or scope of the subject matter of the present invention.

### BRIEF DESCRIPTION OF THE DRAWINGS

The figures mentioned in this section are intended to disclose exemplary embodiments of the claimed system and method. Further, the components/modules and steps of a process are assigned reference numerals that are used throughout the description to indicate the respective components and steps. Other objects, features, and advantages of the present invention will be apparent from the following description when read with reference to the accompanying drawings:

FIG. 1 illustrates a system architecture, according to an exemplary embodiment of the present subject matter.

FIG. 2 is a block diagram of an attention-based deep learning model configured for refining column mappings, according to an exemplary embodiment of the present subject matter.

FIG. 3 illustrates a method for refining column mappings, according to an exemplary embodiment of the present subject matter.

FIG. 4 illustrates a computer environment according to an exemplary embodiment of the present subject matter.

Like reference numerals refer to like parts throughout the description of several views of the drawings.

### DETAILED DESCRIPTION

This section is intended to provide explanation and description of various possible embodiments of the present invention. The embodiments used herein, and various features and advantageous details thereof are explained more fully with reference to non-limiting embodiments illustrated in the accompanying drawings in the following description. The examples used herein are intended only to facilitate an understanding of ways in which the embodiments herein may be practiced and to further enable the person skilled in the art to practice the embodiments used herein. Also, the examples/embodiments described herein should not be construed as limiting the scope of the embodiments herein. Corresponding reference numerals indicate corresponding parts throughout the drawings. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

The specification may refer to “an”, “one”, “different” or “some” embodiment(s) in several locations. This does not necessarily imply that each such reference is to the same embodiment(s), or that the feature only applies to a single embodiment. Single features of different embodiments may also be combined to provide other embodiments.

The present subject matter discloses provisions for refining column mappings using byte level attention based neural model are disclosed. An encoded data may be generated based on a plurality of synthetic data and a plurality of input column names. The encoded data may be generated for each of the one or more bytes present in the input column names. A deep learning (DL) model may be trained to receive the byte level encoded data and identify the meaning associated to it. A plurality of pre-existing column descriptions may be used to verify if the identified at-least one meaning matches with description of existing column descriptions. Subsequently, fine tuning or refining of the meanings may be conducted to adequately obtain corresponding mapping prediction output.

As used herein, ‘processing unit’ is an intelligent device or module, that is capable of processing digital logics and program instructions for refining column mappings using byte level attention based neural model, according to the embodiments of the present subject matter.

As used herein, ‘storage unit’ refers to a local or remote memory device; docket systems; databases; capable to store information including, data, metadata, existing mapping data, existing column description, source table information, destination table information, schemas, data source information, mapping rules etcetera. In an embodiment, the storage unit may be a database server, a cloud storage, a remote database, a local database.

As used herein, ‘user device’ is a smart electronic device capable of communicating with various other electronic devices and applications via one or more communication networks. Examples of said user device include, but not limited to, a wireless communication device, a smart phone, a tablet, a desktop, a laptop, etcetera. The user device comprises: an input unit to receive one or more input data; an operating system to enable the user device to operate; a processor to process various data and information; a memory unit to store initial data, intermediary data and final data pertaining to column mappings and identifying meanings or translation of any byte from a given column name, the user device may also include an output unit having a graphical user interface (GUI).

As used herein, ‘module’ or ‘unit’ refers to a device, a system, a hardware, a computer application configured to execute specific functions or instructions pertaining to determining and refining translation of a given column name according to the embodiments of the present subject matter. The module or unit may include a single device or multiple devices configured to perform specific functions according to the present subject matter disclosed herein.

As used herein, ‘communication network’ includes a local area network (LAN), a wide area network (WAN), a metropolitan area network (MAN), a virtual private network (VPN), an enterprise private network (EPN), the Internet, and a global area network (GAN).

Terms such as ‘connect’, ‘integrate’, ‘configure’, and other similar terms include a physical connection, a wireless connection, a logical connection or a combination of such connections including electrical, optical, RF, infrared, or other transmission media, and include configuration of software applications to execute computer program instructions, as specific to the presently disclosed embodiments, or as may be obvious to a person skilled in the art.

Terms such as ‘send’, ‘transfer’, ‘transmit’ and ‘receive’, ‘collect’, ‘obtain’, ‘access’ and other similar terms refers to transmission of data between various modules and units via wired or wireless connections across a communication network.

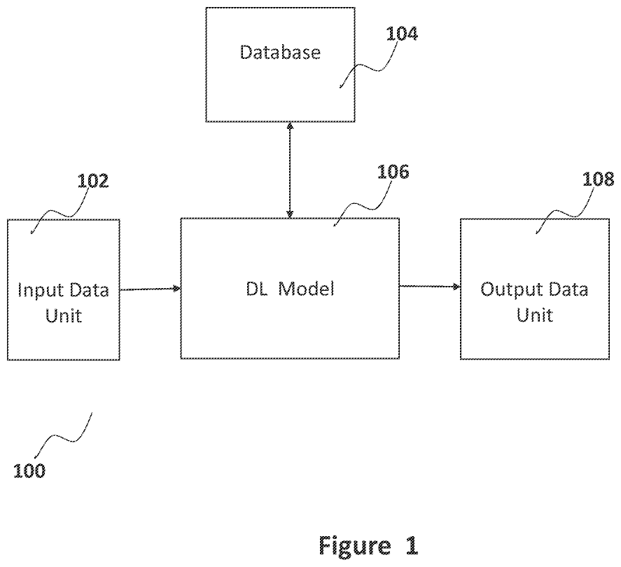

FIG. 1 illustrates architecture of a system 100 for refining column mappings using byte level attention based neural model, according to an exemplary embodiment of the present subject matter. The system 100 according to the present subject matter comprises a plurality of components. For example, and by no way limiting the scope of the present subject matter, the system 100 comprises an input data unit 102, a database 104, a DL model 106, and an output data unit 108.

The input data unit 102 may provide input data for column mapping. The input data may include one or more tables, each table having a plurality of columns and rows. The columns may be given a name by using any of one or more, or combination of alphabets, words, letters, numbers, and alphanumeric strings. The given column names of a table may differ from the column names of other tables. This is due to the fact that column names may be given based on different contexts of the respective tables and also due to the fact that the tables arc received from various multiple data sources. The plurality of data sources may include one or more terminals present at various locations of one or more customers or users to preside input data for data mapping and analytics. The one or more customers may use various terminals or user devices such as smart electronic devices, computer systems, laptops, tablets, or smartphones that are capable of sending and receiving data files pertaining to column mappings over a communication network.

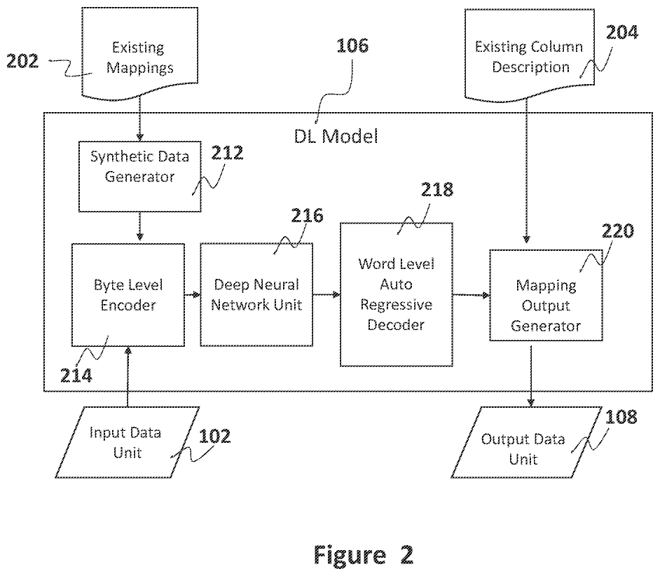

The database 104 may be deployed to store various metadata, recorded information, existing mappings data 202 (FIG. 2), existing column description, historical data etcetera. The database 104 may be connected to a processing unit and a memory. The processing unit may be configured to execute a plurality of computer instructions stored in the memory. The processing unit may be configured to facilitate in determining correct translation and meaning of a given column name.

The mappings data and the historical data stored in the database 104 are fed to the DL model 106 for training the model 106. The DL model 106 identifies meaning of the received data which contains a plurality of columns having respective column names. Each of the plurality of column names typically contains one or more bytes. The DL model 106 analyses the plurality of column names to identify at least one meaning for each byte of each of the input column names. As discussed above, the database 104 also stores a plurality of pre-existing column descriptions which are used to further refine the training of the DL model 106. Once the DL model 106 is trained, a plurality of input column names may be fed into the DL model 106 to obtain highly accurate meaning of the inputted column names.

Based on the plurality of pre-existing column descriptions 204 (FIG. 2), the DL model 106 determines whether or not the identified at least one meaning matches with at least one description of the plurality of column descriptions. Thereafter, the DL model 106 may generate an error score indicating if result of the match is adequate or not. The error score is then used to tine tune the DL model 106 for thereby providing refined meanings for a given column name and obtain corresponding mapping prediction output. The output data unit 108 is provided to produce the output or schema mapping predictions to the users. The output result or mapping predictions may further be provided for a quality check by data experts. According to the embodiments of the present subject matter, the DL model 106 is configured, using a computer processor, to build a continuous process of machine learning based on provided sample data for understanding the meanings of given column names in any format and for any domain. The trained DL model 106 then facilitates in determining the context and meaning of column names of the tables to be compared. The understanding of various different column names by the attention-based DL model 106, facilitates a user to automatically perform fast and accurate data mappings and analytics. In an event, if the meaning as identified by the neural model does not match with the existing column description, then the meaning is aligned with the existing schema column's description. The alignment with least loss translation is identified using the existing schema column's names. In one embodiment of the present subject matter, a tuned version Binary Cross Entropy Loss is used.

FIG. 2 is a block diagram of an attention-based deep learning (DL) model 106 configured for refining column mappings, according to an exemplary embodiment of the subject matter. The DI. model 106 comprises a synthetic data generator 212, a byte level encoder 214, a deep neural network unit 216, a word level auto regressive decoder 218, and a mapping output generator 220. According to the embodiments of the present subject matter, the DL model 106 is trained by using existing mappings data 202. The trained DL model 106 is further used to predict the meaning of input column names received from the input data unit 102. The target of the DL model 106 is to achieve an understanding of the meaning of the given column names and at the same time, to match as close as it can to the actual schema columns' descriptions, i.e., existing column descriptions 204. As mentioned above, the existing mappings data 202 and the existing column descriptions 204 are stored in the database 104 and are fed to the DL model 106.

Initially, the plurality of existing mappings data 202 is received from the plurality of data sources in the form of tables having multiple columns and rows. The existing mappings data 202 include various combinations of source columns and the schema mapping. The existing mappings data 202 are used as sample data to train the DL model 106. However, in order to adequately train the DL model 106, the sample data as provided by the existing mappings data 202 may not be sufficient. Therefore, the samples of existing mappings data 202 are fed to the synthetic data generator 212 to generate synthetic sample data to be used for training the DL model 106. The synthetic data generator 212 may upscale the number of sample data up to several times. For example, a sample size of 3-4 k may be increased to a sample size of 150 k by the synthetic generator to enable the training of the DL model 106. The synthetic data generator 212 increases the sample size by identifying combination of characters which will not affect the meaning behind the name of the column even though order is changed. The increased sample data is a close replica to the existing training data, according to the embodiments of present subject matter, there may be no upper limit to increase a sample size. Further, for each epoch or event, the synthetic data generator 212 randomly samples the data with replacement.

The synthetic data is fed to the byte level encoder 214 which is an embedding layer with one hot encoding for each character as input. The byte level output is fed into the novel attention based deep neural network unit 216. Byte level output is used as part of input to attention based deep neural network unit 216. This attention based deep neural network unit 216 generates the vectors for generating mapping description of the schema level columns. The byte level encoder 214 receives the synthetic data for the purpose of training and a plurality of input column names from the various data sources. Each of the data source may use their own way to name any column in their tables. If one of the columns in a given table, for example, contains customers' or users' addresses, then each data source may have their own formats and their own method for naming of the columns. In this instance, one data source may use ‘CUST-ADD’, while another data source may use ‘USER_ADDRESS1’ to name their respective columns. Here, the context of the column may be depicted as ‘address information of the users or customers’. The context present here must be deduced by the DL model 106 to further deduce the meaning or translation of the given column names and therefore a byte level encoder 214 is configured to depict the meaning of each combination of words, letters, numbers, characters, and abbreviations at the byte level. The byte level encoder 214 breaks every word or every combination of letters and characters present in the column names into separate characters. Each separated character is separately analysed for identifying its meaning based on the existing sample mappings data.

Each of the plurality of input column names may contain at least one byte or a group of bytes. The encoder 214 generates an encoded data for each of the bytes. In other words, each byte is translated by the encoder 214 and fed to the deep neural network unit 216. The column names including any combination of letters, words abbreviations, numbers are deduced at the byte level to depict the meaning of the given column names in form of a tensor. The column names also depict context present in the column, or the table and it is essential to understand the context to provide adequate meaning or translation. For example, a column name given as ‘MBR-FST’ may depict the meaning to be ‘first name of the members’ in that column. In order to understand the relevant meaning of a given column name, the attention-based DL model 106 is trained with a plurality of sample data. The byte-level encoder 214 deploys the generated encoded data to train deep learning (DL) model 106 for identifying at least one meaning for each byte of each of the received plurality of input column names. The attention based deep neural network unit 216 of the DL model 106 is trained to understand grammar, structure of words and sentences, and relevant or most likely meaning behind any column name that was provided to the column. The attention based deep neural network unit 216 also understands from the context of the table's metadata and its meaningful information about the existing schema's columns with respect to any domain. This facilitates in drastically reducing the margin of error and also increases the performance efficiency. In addition to the byte-level encoder 214, a byte pair encoder may also be configured to deduce the meaning of pair of words together. The byte pair encoder thus identities various pairs of words and determines relevant meanings, the DL model 106 uses combined context of all columns of a given source table while mapping a current column name.

The word level decoder auto regressive 218 decodes, at the word level the data received from the neural network unit 216. The word level autoregressive decoder 218 performs layman translation for input column names wherein decoded output, from a current word is used to predict the meaning of another word. The autoregressive decoder 218 decodes the word in one event and in the next event it uses the meaning of the previous word to determine the meaning of the next word and so on. The predicted meanings being generated during such events are saved in the memory. For example, if the neural network unit 216 depicts translation of a column name having a first word as ‘RISK’, second word as ‘CODING’, and the third word as ‘SYSTEM’, then the word level decoder auto regressive 218 will decode the meaning of the column name by taking all the words together thereby depicting that the given column name talks about a ‘Risk Coding System’.

The existing column descriptions 204 are stored in the database 104 and used to configure the mapping output generator 220. The mapping output generator 220 provides top ‘N’ number of best match values to be assessed based on the plurality of pre-existing column descriptions 204. The mapping output generator 220 determines whether or not the identified at-least one meaning matches with at least one description of the plurality of column descriptions, and thereby obtain an error score. Further, the error score is used to fine tune the DL model 106 for thereby providing refined meanings for a given column mime and obtain corresponding mapping prediction output. The output unit is provided to produce the output or schema mapping predictions to the users. The output result or mapping predictions may further be provided for a quality check by data experts. The output results may be stored in the database 104. The output results may also be displayed via a graphical user interface, on display screens of respective user devices for further reviewing, editing, updating, and performing analytics. In one embodiment of the present invention, an application programming interface (API) may be configured to be used for receiving inputs and also for delivering the output results.

The embodiments of the present subject matter thus deploy advanced deep learning (DL) model 106 to predict translations with respect to input column names which can also be verified by matching pre-existing column descriptions 204. The continuous learning of the DL model 106 based on the pre-existing column descriptions 204 facilitates in refilling column mapping between source and target tables having column names in various formats. The embodiments disclosed herein facilitates a user to perform column mappings for various domains and its application is not restricted to any specific domain.

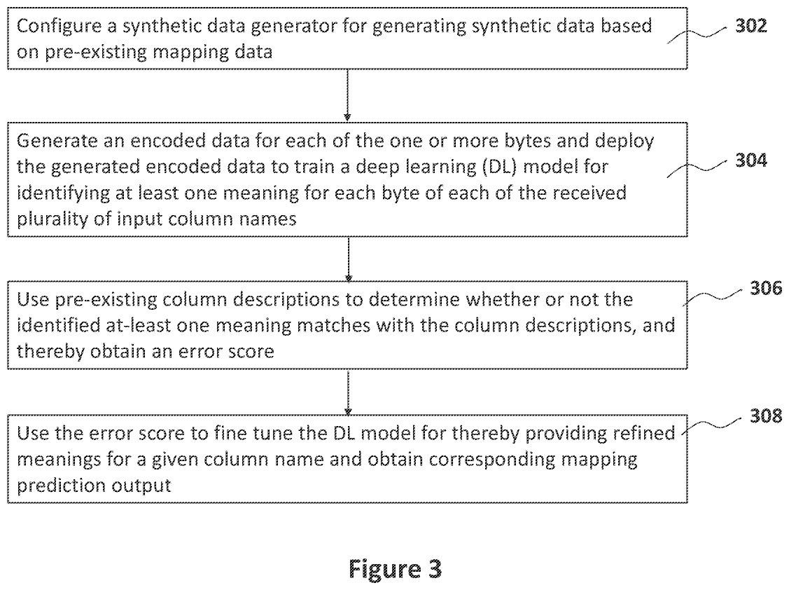

FIG. 3 illustrates a method for refining column mappings, according to an exemplary embodiment of the present subject matter.

At step 302, a synthetic data generator 212 is configured for generating synthetic data based on pre-existing mapping data. A plurality of existing mappings data 202 may be received from the plurality of data sources. The received plurality of mappings data may be used as a sample for training the DL model 106. In order to adequately train the DL model 106, the sample size of the existing mappings data 202 may be large enough to train the DL model 106. Therefore, the samples of existing mappings data 202 are fed to the synthetic data generator 212 to generate synthetic data to upscale the originally available sample size for training the DL model 106. For example, a sample size of 3-4 k may be increased to a sample size of 150 k by the synthetic generator to enable the training of the DL model 106.

At step 304, an encoded data may be generated tor each of the one or more bytes. The byte level encoder 214 may receive the synthetic data and a plurality of input column names from the various data sources. Each of the data source may use their own way to name any column in their tables. The column names may include a combination of several letters, words, characters etcetera. The byte level encoder 214 breaks every word or every combination of letters and characters present in the column names into separate characters. The generated encoded data is thereafter fed to train the deep learning (DL) model 106 for identifying at least one meaning for each byte of each of the received plurality of input column names. The DL model 106 comprises a word level auto regressive decoder that understands grammar, structure of words and sentences, and accordingly translates into relevant or most likely meaning behind any given column name. In addition, the context of the table's metadata and its meaningful information about the existing schema's columns is also depicted by the DL model 106 irrespective of any specific domain.

At step 306, pre-existing column descriptions 204 stored in the database 104 may be used to determine whether or not the identified at-least one meaning matches with the column descriptions, and thereby obtain an error score.

At step 308, the error score may be used to fine tune the DL model 106 to enable it to perform a continuous learning process based on the provided sample data. The mapping prediction output or schema mapping predictions may be presented or displayed to the users. The output result or mapping predictions may further be provided for a quality check by various data experts. The error score is the ‘measure of correctness’ and may be used to fine tune the DL model 106 for thereby providing refined meanings for a given column name and obtain corresponding mapping prediction output.

The embodiments of the present subject matter thus facilitate to speed up the column mapping process between various tables, while providing an accurate translation and understanding of tire context behind a given column name within the tables. Further, the final output is also provided with a quality check by experts thereby providing a holistic solution to provide refined column mappings between tables.

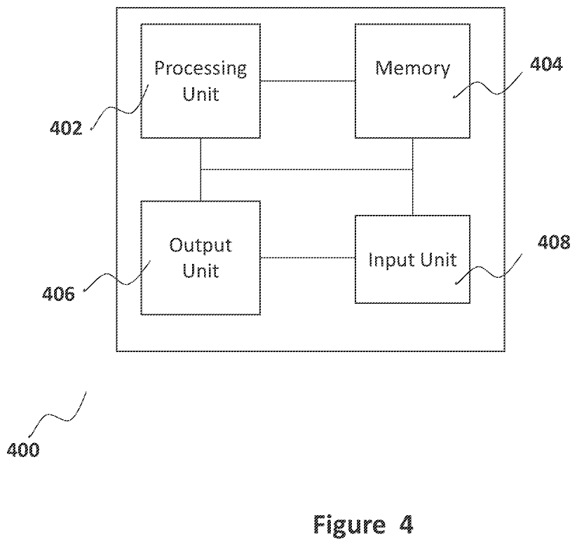

FIG. 4 illustrates computer environment according to an embodiment of the present subject matter. The system is implemented in a computer environment 400 comprising a processor unit connected to a memory 404. The computer environment may have additional components including one or more communication channels, one or more input devices, and one or more output devices. The processor unit executes program instructions and may include a computer processor, a microprocessor, a microcontroller, and other devices or arrangements of devices that are capable of implementing the steps that constitute the method of the present subject matter. The memory 404 stores an operating system, program instructions, mapping information, predefined rules.

The input unit 408 may include, but not limited to, a keyboard, mouse, pen, a voice input device, a scanning device, or any other device that is capable of providing input to the computer system. In an embodiment of the present subject matter, the input unit 308 may be a sound card or similar device that accepts audio input in analog or digital form. The output unit 406 may include, but not limited to, a user interface on CRT or LCD screen, printer, speaker. CD/DVD writer, or any other device that provides output from the computer system.

It will be understood by those skilled in the art that the figures are only a representation of the structural components and process steps that are deployed to provide an environment for the solution of the present subject matter discussed above and does not constitute any limitation. The specific components and method steps may include various other combinations and arrangements than those shown in the figures.

The term exemplary is used herein to mean serving as an example. Any embodiment or implementation described as exemplary is not necessarily to be construed as preferred or advantageous over other embodiments or implementations. Further, the use of terms such as including comprising having containing and variations thereof, is meant to encompass the items/components/process listed thereafter and equivalents thereof as well as additional items/components/process.

Although the subject matter is described in language specific to structural features and for acts, it is to be understood that the subject matter defined in the claims is not necessarily limited to the specific features or process as described above. In fact, the specific features and acts described above are disclosed as mere examples of implementing the claims and other equivalent features and processes which are intended to be within the scope of the claims.

What claimed is:

1. A method for refining column mappings, the method comprising:
configuring a processing unit, the processing unit executing a plurality of computer instructions stored in a memory for:
configuring a synthetic data generator for generating synthetic data based on pre-existing mapping data;
receiving, in an encoder, the synthetic data and a plurality of input column names, each of the plurality of column names being a group of one or more bytes;
generating, by the encoder, an encoded data for each of the one or more bytes;
deploying the generated encoded data to train a deep learning (DL) model having a word level auto regressive decoder for identifying at least one meaning for each byte of each of the received plurality of input column names;
configuring a mapping output generator based on a plurality of pre-existing column descriptions;
using the mapping output generator to determine whether or not the identified at-least one meaning matches with at least one description of the plurality of column descriptions, and thereby obtain an error score; and
using the error score to fine tune the DL model for thereby providing refined meanings for a given column name and obtain corresponding mapping prediction output.

2. The method of claim 1, wherein the encoder is a byte level encoder.

3. The method of claim 1, wherein the encoder is a byte pair encoder.

4. The method of claim 1, wherein the DL model is an attention based neural model.

5. The method of claim 1, wherein the pre-existing mapping data includes one or more sample data received from one or more data sources.

6. The method of claim 1, wherein the DL model identifies the context of all columns of a given source table while mapping a current column name.

7. The method of claim 1, further comprising performing a quality check on the obtained mapping prediction output.

8. A system for refining column mappings, the system comprising:
a processing unit executing a plurality of computer instructions stored in a memory to:
configure a synthetic data generator for generating synthetic data based on pre-existing mapping data;
receive, in an encoder, the synthetic data and a plurality of input column names, each of the plurality of column names being a group of one or more bytes;
generate, by using the encoder, an encoded data for each of the one or more bytes;
deploy the generated encoded data to train a deep learning (DL) model having a word level auto regressive decoder for identifying at least one meaning for each byte of each of the received plurality of input column names;
configure a mapping output generator based on a plurality of pre-existing column descriptions;
use the mapping output generator to determine whether or not the identified at-least one meaning matches with at least one description of the plurality of column descriptions, and thereby obtain an error score; and
use the error score to fine tune the DL model for thereby providing refined meanings for a given column name and obtain corresponding mapping prediction output.

9. The system of claim 8, wherein the encoder is a byte level encoder.

10. The system of claim 8, wherein the encoder is a byte pair encoder.

11. The system of claim 8, wherein the DL model is an attention based neural model.

12. The system of claim 8, wherein the pre-existing mapping data includes one or more sample data received from one or more data sources.

13. The system of claim 8, wherein the DL model identifies the context of all columns of a given source table while mapping a current column name.

14. The system of claim 8, further comprising performing a quality check on the obtained mapping prediction output.
